(19) United States
(12) Patent Application Publication
(10) Pub. No.: US 2009/0196575 A1
(43) Pub. Date: Aug. 6, 2009

(54) INFORMATION PLAYBACK APPARATUS AND PLAYBACK SPEED CONTROL METHOD

(76) Inventor: Yoko Masuo, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/361,046

(22) Filed: Jan. 28, 2009

(30) Foreign Application Priority Data
Jan. 31, 2008 (JP) 2008-020948

(51) Int. Cl. H04N 5/91

(52) U.S. Cl. 386/80; 386/E05.003

(57) ABSTRACT

According to one embodiment, an information playback apparatus comprises a detector module configured to detect a frame information amount of a content item to be played back, and an adjusting module configured to adjust a playback speed of the content item to be played back based on the frame information amount.

### CROSS-REFERENCE TO RELATED APPLICATIONS

This application is based upon and claims the benefit of priority from Japanese Patent Application No. 2008-020948, filed Jan. 31, 2008, the entire contents of which are incorporated herein by reference.

### BACKGROUND

1. Field

One embodiment of the invention relates to an information playback apparatus, which plays back a video content item that is stored in a medium or is supplied via the Internet or the like, and a playback speed control method.

2. Description of the Related Art

In recent years, video discs of DVD, HD DVD, and the like, and DVD/HD DVD players and HDD/DVD recorders which play back these discs have rapidly prevailed. It has become a mainstream to view content data such as a television broadcast and the like once it is recorded on an HDD or DVD. In such situation, the lack of time required to view such a huge amount of content is a major issue for viewers.

Conventionally, an information playback apparatus which plays back an audio of a video tape recorder or the like has a double-speed playback function, high-speed fast-forwarding function, and the like that allow the user to view a full-length movie in a short period upon playback. For example, a variable-speed playback apparatus which allows the user to easily view and can eliminate unnatural or inaudible sound is available (for example, see Jpn. Pat. Appln. KOKAI Publication No. 2006-121570 (paragraph 0024)).

In this apparatus, upon recording a content item including video data and audio data in a recording module, the make-up of each interval content item between neighboring scene changes are classified into a plurality of elements for respective audio data and video data to create a map for respective scene changes of the content item, and the map is recorded in the recording module. Upon playing back the content item from the recording unit, elements associated with audio data and video data corresponding to the interval content item to be played back are read from the map, thereby varying the playback speed of the interval content item. More specifically, audio data are classified into a conversation part, music/effect sound part, and silent part, video data are classified into a hard motion part, middle motion part, and nearly still picture part, and the playback speed is determined by combining these parts.

On the other hand, in the advanced HD DVD, a plurality of types of sub-picture data including related additional information are provided with respect to single main picture data, and two or more types of sub-picture data are displayed at the same time, thus allowing a variety of viewing modes. In such situation, since an information amount per frame increases, a demand has arisen for playback of a content item at a speed lower than a normal speed depending on scenes.

As the apparatus described in the above patent document has to create and record a map upon recording a content item, it suffers a hardware load that requires to add a circuit used to create a map, and a processing load that needs an extra time for creation, and needs an extra storage area for recording the map. Since the apparatus is premised on that a content item is recorded once to create a map, it is not suited to play back a copy-protected content item that does not permit a content item recording operation itself. Furthermore, the apparatus described in above patent document cannot cope with a demand to play back at a speed lower than the normal speed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the overall system of an information processing apparatus according to an embodiment of the invention;

FIG. 2 is an exemplary view showing the data structure of a sub-picture unit SPU;

FIG. 3 is an exemplary view showing the detailed data structure of the sub-picture unit SPU;

FIGS. 4A, 4B, 4C, 4D, and 4E are exemplary views showing run-length compression rules to be applied to sub-picture pixel data PXD;

FIG. 5 is an exemplary view showing assignment of the sub-picture pixel data PXD;

FIG. 6 is an exemplary view showing the data structure of a display start timing forced setting command FSTA_DSP;

FIG. 7 is an exemplary view showing the data structure of a display start timing setting command STA_DSP;

FIG. 8 is an exemplary view showing the data structure of a display stop timing setting command STP_DSP;

FIG. 9 is an exemplary view showing the data structure of a color code setting command SET_COLOR;

FIG. 10 is an exemplary view showing the data structure of a contrast setting command SET_CONTR;

FIG. 11 is an exemplary view showing the data structure of a display area setting command SET_DAREA;

FIG. 12 is an exemplary view showing the data structure of a PXD start address setting (SD) command SET_DSPXA;

FIG. 13 is an exemplary view showing the data structure of color code/contrast change command CHG_COLCON;

FIG. 14 is an exemplary view showing the make-up of pixel control data PXCD;

FIG. 15 is an exemplary view showing the make-up of line control data LN_CTLI;

FIG. 16 is an exemplary view showing the make-up of pixel control data PX_CTLI;

FIG. 17 is an exemplary view showing the data structure of a PXD start address setting (HD) command SET_DSPXA2;

FIG. 18 is an exemplary view showing the data structure of a display forced end command CMD_END;

FIG. 19 is an exemplary flowchart showing the processing sequence of playback speed control;

FIG. 20 is an exemplary view showing an effective display area of a sub-picture; and

FIG. 21 is an exemplary view showing a database for playback speed adjustment.

### DETAILED DESCRIPTION

Various embodiments according to the invention will be described hereinafter with reference to the accompanying drawings. In general, according to one embodiment of the invention, an information playback apparatus comprises: a detector module configured to detect a frame information amount of a content item to be played back; and an adjusting module configured to adjust a playback speed of the content item to be played back based on the frame information amount.

An embodiment of an information playback apparatus according to the invention will be described hereinafter with reference to the accompanying drawings. The invention is applicable to playback of a content item recorded on an information recording medium such as a hard disk HDD, an optical disc DVD, and the like, and that of a content item downloaded from the Internet. The invention is not limited to players and HDD/DVD recorders which play back video discs of DVD, HD DVD, and the like, but is also applicable to a television receiver which incorporates an HDD.

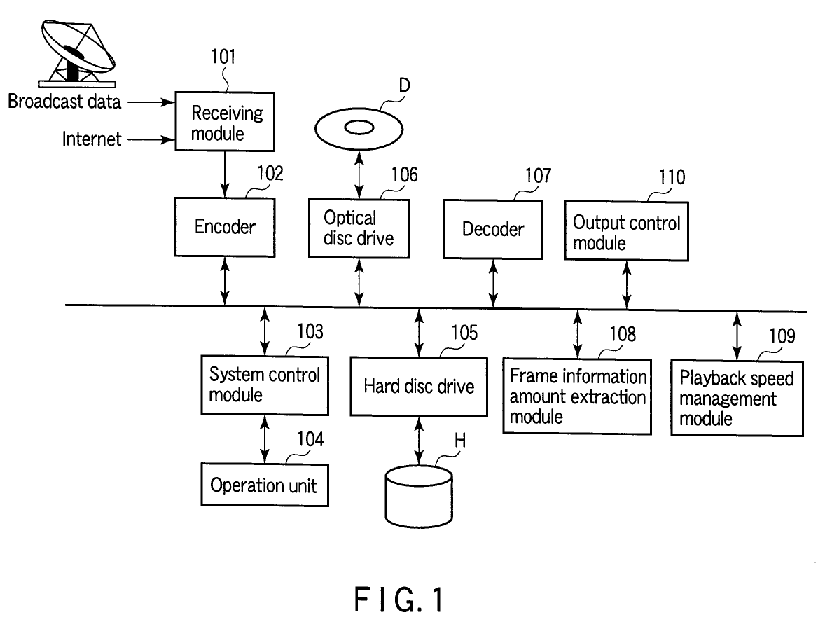

FIG. 1 is a block diagram showing the arrangement of the overall system of an information playback apparatus according to the first embodiment of the invention. A receiving module 101 is a processing module which receives content data via a network. Note that the network includes broadcasting waves of satellite broadcasting, terrestrial broadcasting, CATV, IP broadcasting, and the like, and communications via the Internet and the like, and the invention is not limited to any specific network.

A system control module 103 is a processing module, which systematically controls the operations of respective processing modules of this system. An operation unit 104 connected to the system control module 103 receives various control commands externally from a remote controller or the like, and passes these control commands to the system control module 103. The control commands include those used to instruct to record program data, to play back the recorded program data, and the like.

When the system control module 103 issues a video recording instruction, the content data received by the receiving module 101 is encoded by an encoder 102, and is recorded on a hard disc H via a hard disc drive 105 or on an optical disc D via an optical disc drive 106.

When the system control module 103 issues a playback instruction of the content item recorded on the hard disc H or optical disc D, the content data read from each recording medium is decoded by a decoder 107, and is supplied to an output control module 110. The output control module 110 synchronizes decoded video and audio data using information associated with a display time such as a PTS (Presentation Time Stamp) and the like included in these decoded video and audio data, and information of an STC (System Time Clock) of a player, thus outputting these data onto a display screen. The sequence of data upon normal playback has been described.

In this embodiment, the information playback apparatus further comprises a processing module 108 which quantitatively extracts a frame information amount from the decode result of the decoder 107, and a playback speed management module 109 which adjusts and manages the playback time/playback speed specified by the display time information PTS and the like in accordance with the extracted frame information amount. The frame information amount is associated with the importance of each frame, and indicates a duration required to view that frame. For example, in case of a content item having a subtitle, the size of a sub-picture as a subtitle picture and the number of characters of the subtitle can be used as the frame information amount. When the information amount of the subtitle is small, no problem is posed if a high playback speed is set. When the information amount of the subtitle is large, it is preferable to set a low playback speed since the viewer's reading speed cannot catch up the subtitle playback speed unless it is played back slowly. In addition, motion vectors, audio information amount, and the like may be used as the frame information amount. A motion-less part such as a scene in which several persons including a leading character are looking at each other in a drama or the like may be played back at a high speed. However, since a hard motion part requires a large information amount, it is preferable to set a low playback speed. A scene with a small audio amount may be played back at a high speed. However, it is preferable to play back a scene with a large audio amount, so as to avoid inaudibleness.

In this way, according to this embodiment, the playback speed is automatically adjusted so as to play back only a scene with a small information amount (less important scene) at a high speed and to play back a scene with a large information amount (important scene) at a speed as high as possible within a viewable range. In this way, the viewer can view a full-length content item in a short period and at an easy-to-follow speed, thus greatly improving the viewing efficiency.

A practical example that uses a display area size of a sub-picture as a frame information amount will be explained below. A content item includes many scenes including no sub-picture, and a case will be explained below wherein a scene including no sub-picture is played back at a high speed, and the playback speed of a scene including a sub-picture is automatically adjusted according to its frame information amount.

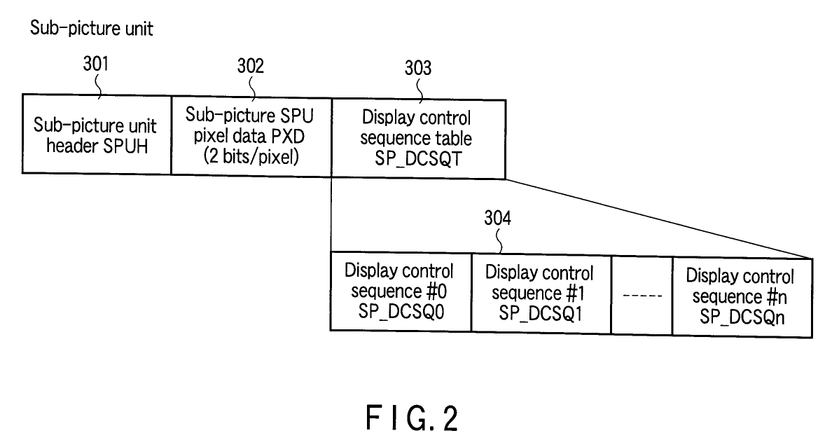

A sub-picture format of the DVD standard will be described below with reference to FIGS. 2 to 18.

A sub-picture unit (SPU: Sub Picture Unit) which configures a sub-picture includes a sub-picture unit header (SPUH: Sub-picture Unit Header) 301, sub-picture pixel data (PXD: Pixel Data) 302, and display control sequence table (SP_DCSQT: SP Display Control Sequence Table) 303, as shown in FIG. 2. The sub-picture pixel data (PXD) 302 includes 2 bits/pixel. The display control sequence table (SP_DCSQT) 303 includes display control sequences SP_DCSQ#0 to SP_DCSQ#n.

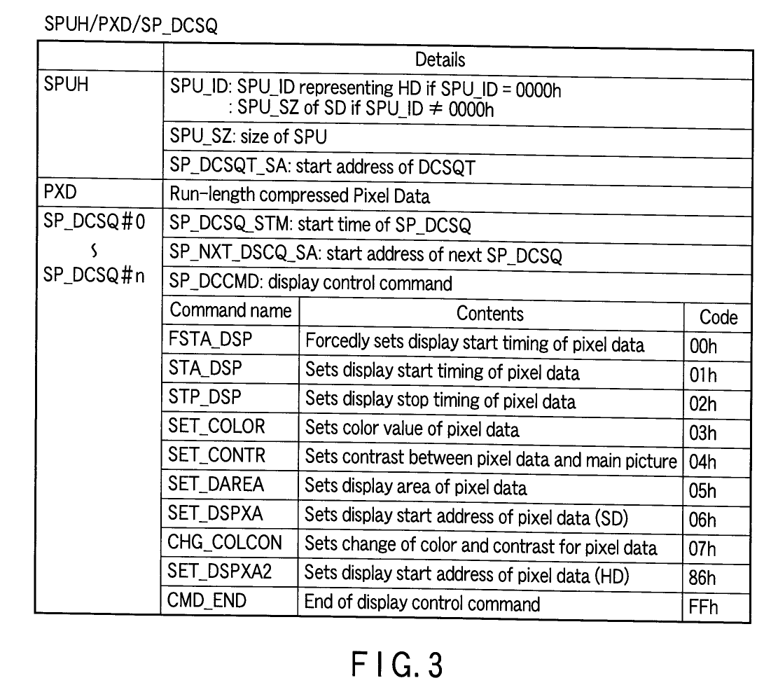

FIG. 3 shows the detailed data structure of the sub-picture unit SPU. The sub-picture unit header (SPUH) 301 includes SPU identification information SPU_ID, an SPU size SPU_SZ, and a DCSQT start address SP_DCSQT_SA. The sub-picture pixel data (PXD) 302 is run-length-compressed pixel data. The HD DVD standard also defines a format in which 8 bits/pixel sub-picture data (PXD) in this embodiment is obtained by compression according to other run-length compression rules.

A plurality of display control sequences SP_DCSQ#0 to SP_DCSQ#n may exist for identical data PXD. For example, a plurality of sequences DCSQ exist for identical data PXD for a use application such as a subtitle of KARAOKE when identical display characters are to be displayed while changing their color and scrolling these characters along with an elapse of time.

Each of the display control sequences SP_DCSQ#0 to SP_DCSQ#n includes a start time SP_DCSQ_STM of the display control sequence SP_DCSQ, next SP_DCSQ start address SP_NX_DCSQ_SA, and display control commands SP_DCCMD.

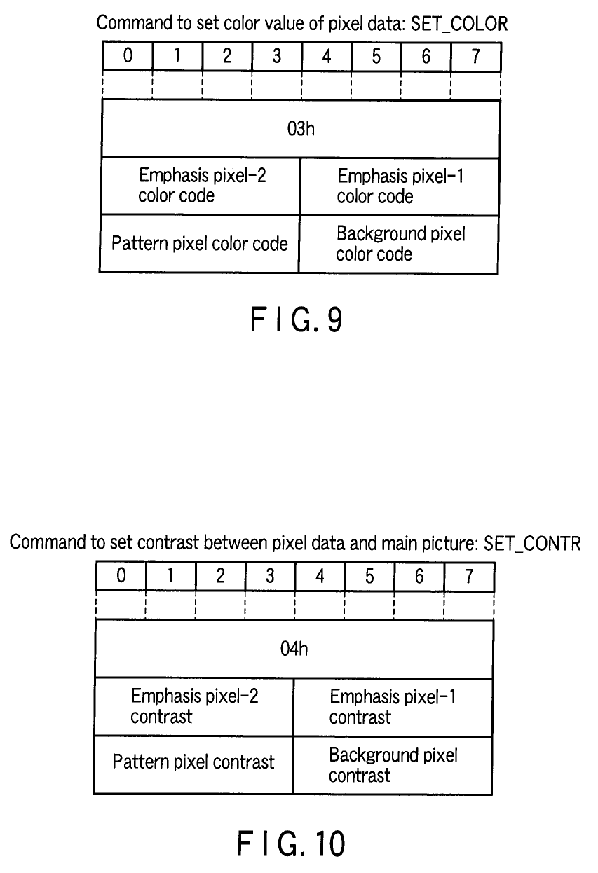

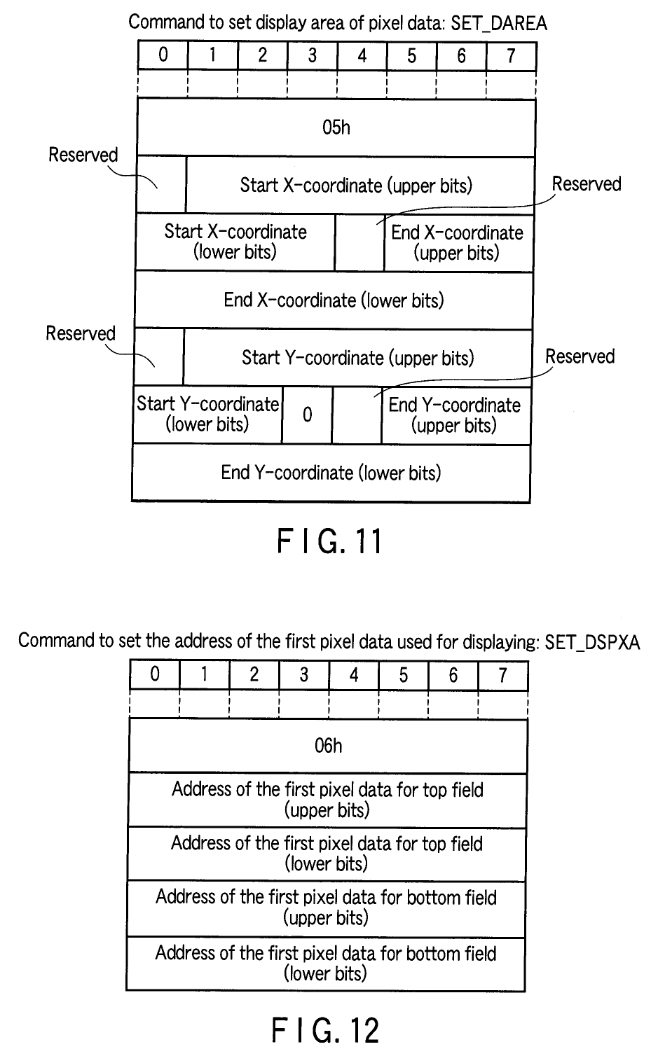

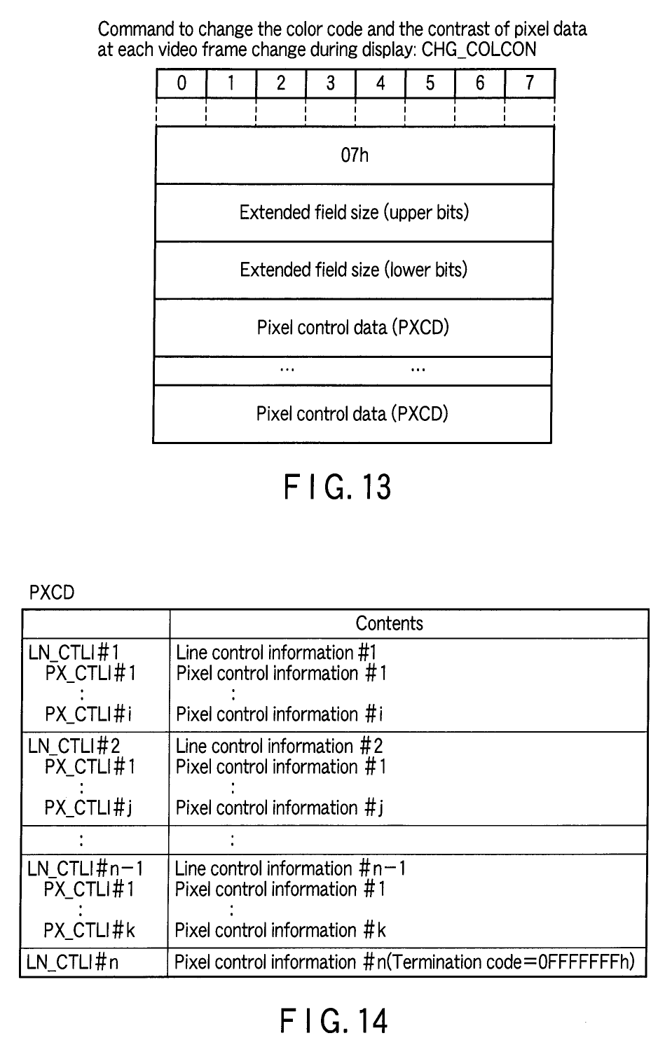

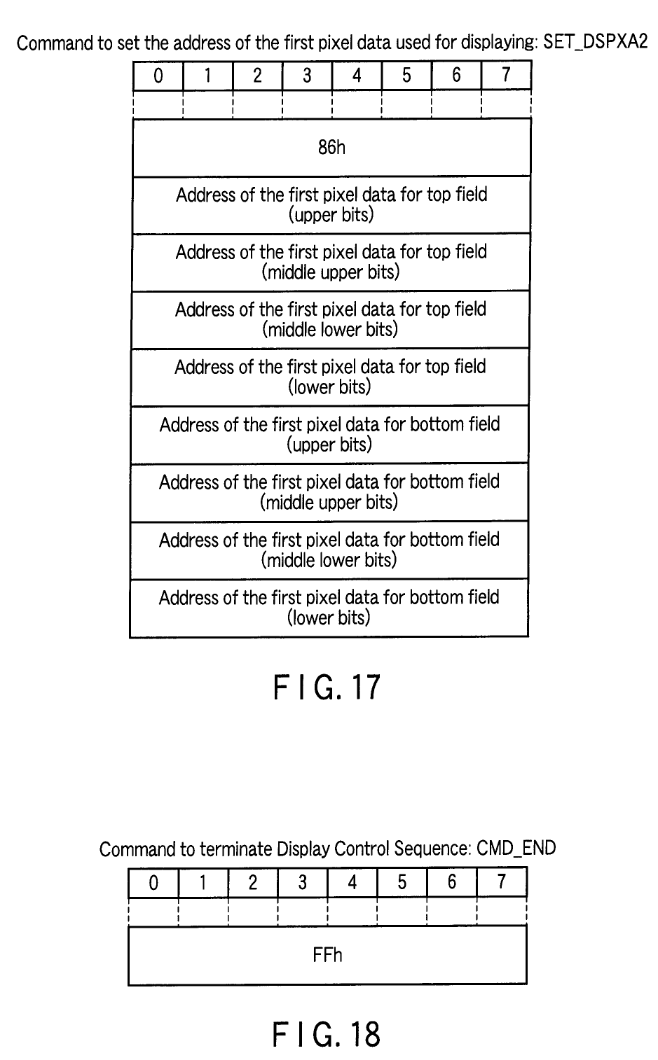

The display control commands SP_DCCMD include a display start timing forced setting command FSTA_DSP (see FIG. 6), display start timing setting command STA_DSP (see FIG. 7), display stop timing setting command STP_DSP (see FIG. 8), color code setting command SET_COLOR (see FIG. 9), contrast setting command SET_CONTR (see FIG. 10), display area setting command SET_DAREA (see FIG. 11), PXD start address setting (SD) command SET_DSPXA (see FIG. 12), color code/contrast change command CHG_COLCON (see FIG. 13), PXD start address setting (HD) command SET_DSPXA2 (see FIG. 17), and display control command end command CMD_END (see FIG. 18).

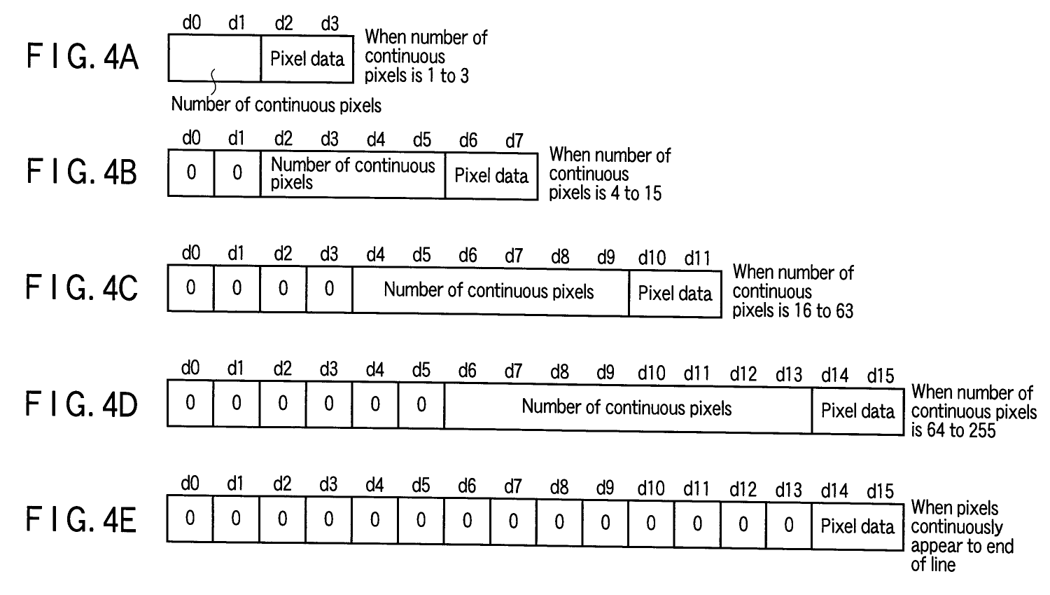

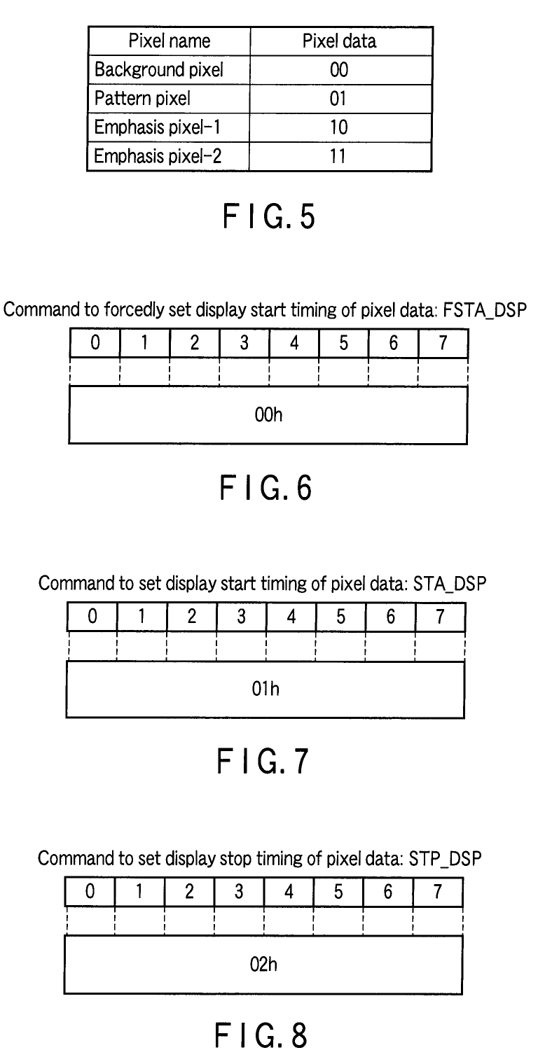

Pixel data is bitmap data compressed according to run-length compression rules shown in FIGS. 4A to 4E. Assignment of each 2-bit pixel data to a bitmap is as shown in FIG. 5. Bits “00” are assigned to a background pixel; “01” to a pattern pixel; “10” to an emphasis pixel-1 ; and “11” to an emphasis pixel-2 .

The run-length compression rules change according to the number of continuous pixels when pixel data having an identical value successively (continuously) appear.

(1) When 4 bits form one unit (FIG. 4A)

When 1 to 3 pixel data with an identical value continuously appear, the first 2 bits indicate the number of continuous pixels, and the subsequent 2 bits represent practical pixel data.

(2) When 8 bits form one unit (FIG. 4B)

When 4 to 15 pixel data with an identical value continuously appear, the first 2 bits are set to zero. The subsequent 4 bits indicate the number of continuous pixels, and the last 2 bits represent practical pixel data.

(3) When 12 bits form one unit (FIG. 4C)

When 16 to 63 pixel data with an identical value continuously appear, the first 4 bits are set to zero. The subsequent 6 bits indicate the number of continuous pixels, and the last 2 bits represent practical pixel data.

(4) When 16 bits form one unit (FIG. 4D)

When 64 to 255 pixel data with an identical value continuously appear, the first 6 bits are set to zero. The subsequent 8 bits indicate the number of continuous pixels, and the last 2 bits represent practical pixel data.

(5) When 16 bits form one unit (FIG. 4E)

When pixel data with an identical value successively appear to the end of one line, the first 14 bits are set to zero. The last 2 bits represent practical pixel data.

The display start timing forced setting command FSTA_DSP is a command for forcibly setting a display start timing of pixel data of a sub-picture unit irrespective of ON/OFF of a sub-picture display state, and its code is 00h, as shown in FIG. 6.

The display start timing setting command STA_DSP is a command for setting a display start timing of pixel data of a sub-picture unit, and its code is 01h, as shown in FIG. 7.

The display stop timing setting command STP_DSP is a command for setting a display stop timing of pixel data of a sub-picture unit, and its code is 02h, as shown in FIG. 8.

The color code setting command SET_COLOR is a command for setting a color of each pixel of pixel data, and its code is 03h, as shown in FIG. 9. Extended fields describe color codes of an emphasis pixel-2 color code, emphasis pixel-1 color code, pattern pixel color code, and background pixel color code.

The contrast setting command SET_CONTR is a command for setting contrast between respective pixels of pixel data and a main picture, and its code is 04h, as shown in FIG. 10. Extended fields describe contrast values of an emphasis pixel-2 contrast, emphasis pixel-1 contrast, pattern pixel contrast, and background pixel contrast.

The display area setting command SET_DAREA is a command for setting a display area of pixel data as a rectangle, and its code is 05h, as shown in FIG. 11. Extended fields describe the X- and Y-coordinates of the start and end points of the rectangular display area.

The PXD start address setting (SD) command SET_DSPXA is a command for setting the address of display start pixel data, and its code is 06h, as shown in FIG. 12. Extended fields describe PXD start addresses of top and bottom fields.

The color code/contrast change command CHG_COLCON is a command for changing the color and contrast of pixel data of each video frame change which is being played back, and its code is 07h, as shown in FIG. 13. Extended fields describe the extended field size, and pixel control data PXCD.

The pixel control data PXCD is data used to control the color and contrast of pixel data, and includes line control information LN_CTLI and pixel control information PX_CTLI, as shown in FIG. 14. The line control information LN_CTLI designates lines to which an identical change is applied, and the pixel control information PX_CTLI designates a position to be changed on the line.

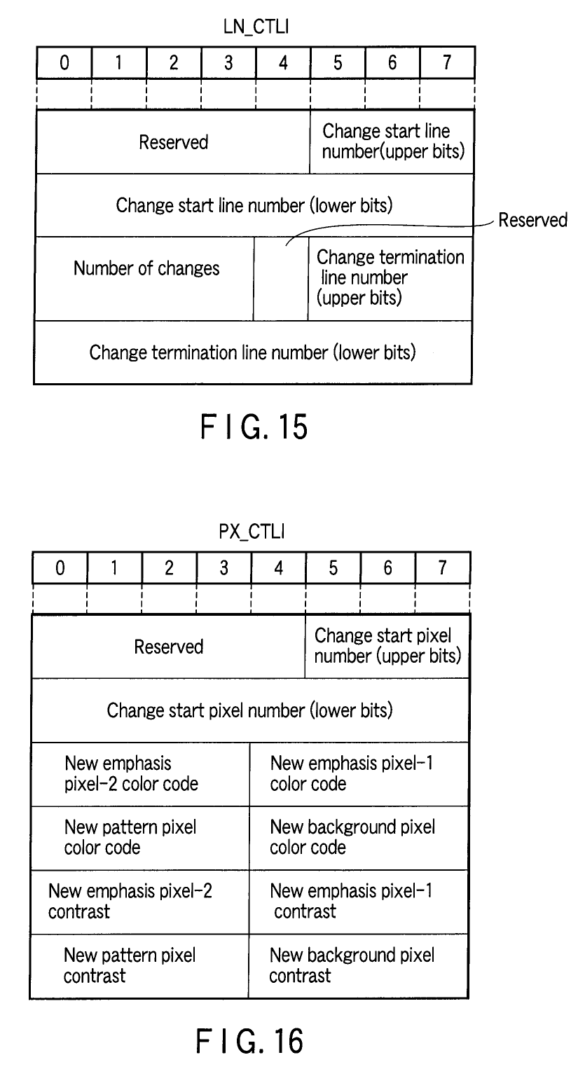

The line control information LN_CTLI describes a change start line, the number of change points, and change end line, as shown in FIG. 15.

The pixel control information PX_CTLI describes a change start point, change end point, and the colors and contrast values of a new emphasis pixel-2, a new emphasis pixel-1, a new pattern pixel, and a new background pixel after change, as shown in FIG. 16.

The PXD start address setting (HD) command SET_DSPXA2 is a command for setting the address of the first pixel data used for displaying, and its code is 86h, as shown in FIG. 17. Extended fields describe the PXD start addresses of top and bottom fields.

The display control command end command CMD_END is a command for terminating the display control sequence, and its code is FFh, as shown in FIG. 18.

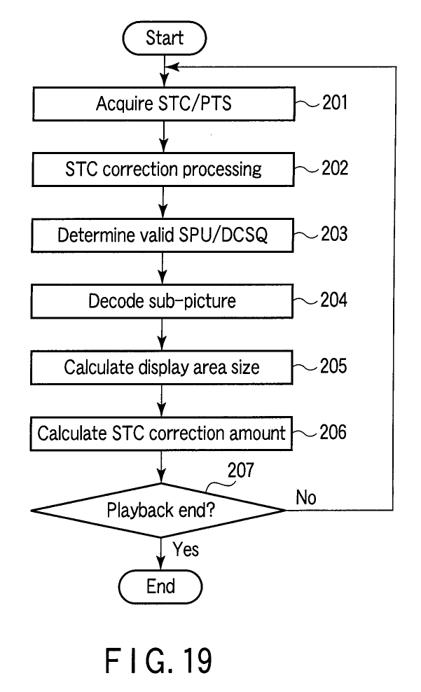

The processing sequence for controlling the playback speed will be described below using FIG. 19.

In block 201, the decoder 107 acquires STC/PTS values from the system control module 103.

In block 202, the STC value is corrected using a correction coefficient. Letting STC' be the corrected STC, the correction is described by:

STC′=STC×correction coefficient

The correction coefficient is determined in block 206 to be described later. If the correction coefficient is not determined yet, the correction is skipped.

In block 203, a sub-picture unit is decoded to obtain a currently valid sub-picture unit SPU# (to be displayed) and its display control sequence DCSQ# based on the following formula. Letting SPU#n of the current sub-picture unit and PTS(SPU#n) be the PTS of the SPU#n, if

STC′≧PTS(SPU#n)

the process advances to the next SPU#n+1.

If STC′<PTS(SPU#n), that SPU#n is valid.

If a valid SPU is determined, a display control sequence DCSQ# which meets STC′=PTS+(DCSQ_STM<<10) is acquired from the display control sequences DCSQ#0 to DCSQ#n of that SPU. Note that “DCSQ_STM<<10” means to shift DCSQ_STM 10 bits to the left. By adding DCSQ_STM<<10 and PTS, a duration required for display is detected.

In block 204, the DCSQ# of the obtained SPU# is decoded.

In block 205, a sub-picture display area size (the number of pixels) is calculated based on the X- and Y-coordinates of the start and end points of a rectangular sub-picture display area in the display area setting command SET_DAREA (FIG. 11) in the decode result of the DCSQ#.

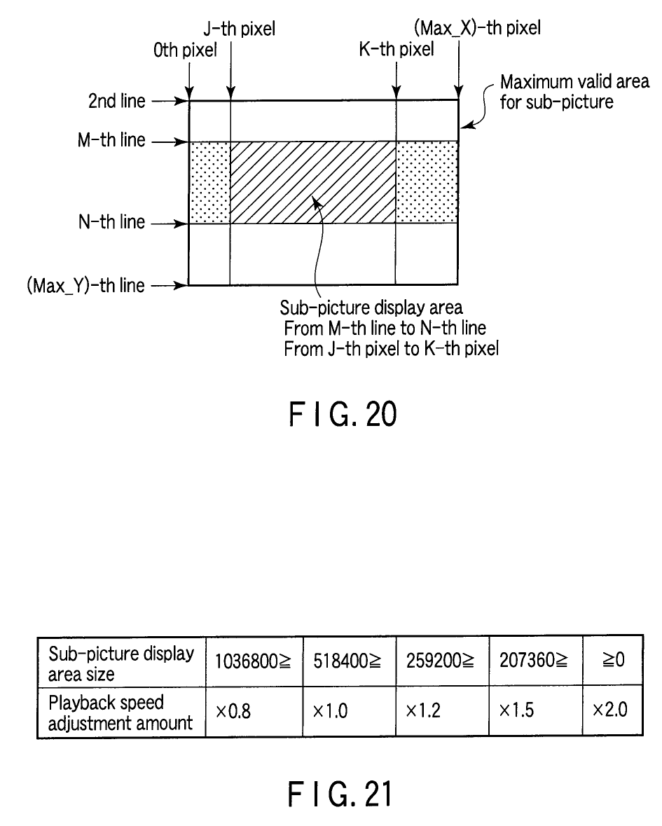

FIG. 20 shows a sub-picture maximum effective display area. If a sub-picture display area is defined by the J-th to K-th pixels of the M-th to N-th lines, a maximum effective display area is defined as follows.

0≦Max_X≦719 (in case of an SD content item), 1919 (in case of an HD content item), 2≦Max_Y≦479 (in case of an NTSC (SD) method), 574 (in case of a PAL (SD) method), 1079 (in case of an HD content item)

0≦J≦K≦Max_X

2≦M≦N≦Max_Y

In block 206, the STC correction amount is determined in accordance with the sub-picture display area size calculated in block 205. For example, a database which represents the relationship between the display area size and correction coefficient, as shown in FIG. 21, may be prepared in advance. FIG. 21 shows an example of a case of a full HD size. In FIG. 21, when the sub-picture display area size occupies ½ or more of the full screen size, a playback speed adjustment amount (correction coefficient) is set to ×0.8 (slightly low speed); when it occupies ¼ or more to less than ½ of the full screen size, the adjustment amount is set to ×1.0 (equal speed); or when no sub-picture exists, the adjustment amount is set to ×2.0 (double speed). This database may be set in advance by a manufacturer before delivery of the apparatus, or may be externally designated by user's operations. The adjustment amounts for respective display areas and the number of classes of the display areas are not limited to those shown in FIG. 21, and they may be arbitrarily changed.

It is determined in block 207 if a playback end instruction is issued. The processes from block 201 are repetitively executed until the playback end instruction is issued.

As described above, according to the first embodiment, a frame information amount is extracted from a content item to be played back, and the content item playback speed can be automatically adjusted so as to play back only a scene with a small information amount (less important scene) at a higher speed, and to play back a scene with a large information amount (important scene) at a speed as high as possible within a viewable range. For this reason, the viewer can view a full-length content item in a short period and at an easy-to-follow speed, thus greatly improving the viewing efficiency.

According to the embodiment, it is provided an information playback apparatus and a playback speed control method, which automatically convert a playback speed of a content item to that optimal to a viewer and output the content item at the converted speed by automatically extracting a frame information amount of the content item and adjusting the playback speed of the content item according to the extracted frame information amount. The viewer can view a content item within a short period and at a speed at which he or she can easily follow the content item without interrupting playback, thus allowing efficient viewing of a huge amount of content.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, in the above description, the frame information amount uses the sub-picture display area size. However, the invention is not limited to this. For example, the information amount (the number of characters and the like) of subtitle information, that of audio information, the motion vectors of a frame, and the like, which are included in a content item, may be used. A function of automatically turning off an audio output upon execution of high-speed playback may be added. When the user changes the playback speed adjustment database shown in FIG. 21 for respective content items according to his or her preference, the changed database may be stored in a nonvolatile storage area in correspondence with each content item.

What is claimed is:

1. An information playback apparatus comprising:
a detector module configured to detect a frame information amount of a content item to be played back; and
an adjusting module configured to adjust a playback speed of the content item to be played back based on the frame information amount.

2. The apparatus of claim 1, further comprising a playback control module configured to determine a playback timing of frame information of the content item to be played back by comparing display time information acquired from the frame information with a system time clock, and
in which the adjusting module is configured to adjust the system time clock based on the frame information amount, and
the playback control module is configured to compare the display time information and the adjusted system time clock.

3. The apparatus of claim 2, wherein the adjusting module is configured to adjust the playback speed to be higher as the frame information amount is smaller and adjust the playback speed to be lower as the frame information amount is larger.

4. The apparatus of claim 3, wherein the adjusting module includes a database in which a relationship between the frame information amount and an adjustment amount is set, and the database is configured to be changed by a user's operation.

5. The apparatus of claim 1, wherein the detecting module is configured to detect the frame information amount based on at least one of a sub-picture display area size, an information amount of subtitle information, an information amount of audio information, and motion vectors of a frame, which are included in the content item to be played back.

6. The apparatus of claim 5, wherein the detecting module comprises a calculation module configured to calculate the sub-picture display area size based on a decode result of a display area setting command included in a display control sequence of a sub-picture unit.

7. A playback speed control method comprising:
detecting a frame information amount of a content item to be played back; and
adjusting a playback speed of the content item to be played back based on the frame information amount.

8. The method of claim 7, further comprising:
acquiring display time information from the frame information of the content item to be played back; and
determining a playback timing of the frame information by comparing the acquired display time information with a system time clock, and
in which the adjusting is configured to adjust the system time clock based on the frame information amount, and
the determining the playback timing comprises comparing the display time information with the adjusted system time clock.

9. The method of claim 8, wherein the adjusting is configured to adjust the playback speed to be higher as the frame information amount is smaller, and adjust the playback speed to be lower as the frame information amount is larger.

10. The method of claim 9, wherein the adjusting comprises setting an adjustment amount based on a database in which a relationship between the frame information amount and the adjustment amount is set, and the database is configured to be changed by a user's operation.

11. The method of claim 7, wherein the detecting is configured to detect the frame information amount based on at least one of a sub-picture display area size, an information amount of subtitle information, an information amount of audio information, and motion vectors of a frame, which are included in the content item to be played back.

12. The method of claim 11, wherein the detecting comprises calculating the sub-picture display area size based on a decode result of a display area setting command included in a display control sequence of a sub-picture unit.
